(19) United States
(12) Patent Application Publication
(10) Pub. No.: US 2026/0267516 A1
(43) Pub. Date: Sep. 10, 2026

(54) READ TRANSACTIONS MANAGEMENT IN A MEMORY CONTROLLER

(71) Applicant: SKYECHIP BERHAD, BAYAN LEPAS (MY)

(72) Inventors: Soon Chieh LIM, BAYAN LEPAS (MY); Zhen Peng CHOK, BAYAN LEPAS (MY)

(73) Assignee: SKYECHIP BERHAD, BAYAN LEPAS (MY)

(21) Appl. No.: 19/077,141

(22) Filed: Mar. 12, 2025

(30) Foreign Application Priority Data
Mar. 4, 2025 (MY) PI2025001434

(51) Int. Cl. G06F 3/06

(52) U.S. Cl. CPC G06F 3/0613; G06F 3/0659; G06F 3/0673

(57) ABSTRACT

A method for managing read transaction in a memory controller includes receiving a plurality of read request from an initiator requesting read data from an external memory device; storing the plurality of read request sequentially in a read retirement buffer; assigning each read request to a transaction-ID tracker based on its transaction ID; marking a Data Valid status for the read request; marking a Head Data Valid status for the transaction ID tracker; arbitrating the order of retirement of said read request where the Head Data Valid status is marked complete; and returning read data to the initiator in the order determined during arbitration process. An apparatus of a memory controller for managing read transactions is disclosed herein.

This is a Non-Provisional application which claims priority to Malaysian Application No. PI2025001434 filed Mar. 4, 2025. The disclosure of the prior application is hereby incorporated by reference herein in its entirety.

### TECHNICAL FIELD

The present invention pertains to the field of memory controller design, and more specifically, to methods and systems for managing the order of read transactions in memory systems.

### BACKGROUND ART

Memory controllers are essential components in modern computing systems, responsible for managing data transfer between processors and memory devices. In many systems, read requests from different threads can be issued out-of-order, while the correct order of data return must be maintained to ensure proper system operation. Traditional memory controllers often employ complex arbitration logic to manage the order of read responses, which can lead to increased latency and higher power consumption.

Below are several examples of prior arts related to managing read transaction in a memory controller.

United States of America patent publication no. U.S. Pat. No. 6,772,300B1 disclosed a computer system comprises a main memory; and a chip set coupled to the main memory. The chip set comprises a transaction memory, a first bank controller and a second bank controller coupled to the transaction memory. The first bank controller stores transaction data to be transmitted to a first bank of main memory within the transaction memory according to a first linked list. The second bank controller stores transaction data to be transmitted to a second bank of main memory within the transaction memory according to a second linked list.

Another example is disclosed in United States of America patent publication no. US2012331197A1 which relates to a memory controller for controlling access to a memory device of the type having a non-uniform access timing characteristic. An interface receives transactions issued from at least one transaction source and a buffer temporarily stores as pending transactions those transactions received by the interface that have not yet been issued to the memory device. The buffer maintains a plurality of ordered lists (having a number of entries) for the stored pending transactions, including at least one priority based ordered list and at least one access timing ordered list. Each entry being associated with one of the pending transactions and ordered within its priority based ordered list based on the priority indication of the associated pending transaction. Arbitration circuitry performs an arbitration operation during which the plurality of ordered lists are referenced so as to select a winning transaction to be issued to the memory device.

Furthermore, United States of America patent publication no. US2009019238A1 disclosed a memory controller receives read requests from a processor into a read queue. The memory controller dynamically modifies an order of servicing the requests based on how many pending requests are in the read queue. When the read queue is relatively empty, requests are serviced oldest first to minimize latency. When the read queue becomes fuller, requests are serviced in a manner that maximizes throughput on a memory bus to reduce the likelihood that the read queue will become full and further requests from the processor would have to be halted.

It is evident that the existing read transaction managing methods and systems lack features to efficiently manage and prioritize read transaction with the same transaction ID.

### SUMMARY OF THE INVENTION

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

It is an objective of the present invention to provide a method and apparatus for efficiently managing out-of-order read transactions in memory controllers.

It is also an objective of the present invention to develop a scalable solution for handling a large number of outstanding read transactions.

Accordingly, these objectives may be achieved by following the teachings of the present invention. The present invention proposes a method for managing read transaction in a memory controller, characterized by the steps of: receiving a plurality of read request from an initiator requesting read data from an external memory device, each read request is associated with a transaction ID; storing the plurality of read request sequentially in a read retirement buffer, with a retirement buffer entry number associated with each entry of the read request; assigning each read request to a transaction-ID tracker based on its transaction ID, wherein an unused transaction ID tracker is selected and assigned to the read request if the transaction ID is not previously recorded in the read retirement buffer, the read request having the same transaction ID with an earlier read request in the read retirement buffer is assigned to the same transaction ID tracker, the transaction ID tracker is recorded with a first retirement buffer entry number and a last retirement entry buffer number associated with the transaction ID tracker; marking a Data Valid status for the read request when the read data for the read request is returned from the external memory device; marking a Head Data Valid status for the transaction ID tracker when the Data Valid Status is marked complete for the first retirement buffer entry number associated with the transaction ID tracker; arbitrating the order of retirement of said read request where the Head Data Valid status is marked complete, by selecting the next request for data return, based on their sequence within their respective transaction-ID trackers; and returning read data to the initiator in the order determined during arbitration process.

Moreover, the present invention propose a memory controller for managing read transactions, characterized by: a read retirement buffer for sequentially storing read request and associating a read retirement buffer number with each entry of the read requests; a plurality of transaction-ID trackers, each tracker is associated with a group of read requests having the same transaction ID, each transaction-ID tracker stored a first and last retirement buffer entry number of the read requests associated with the transaction ID tracker; a data-validity tracking module configured to: set a Data Valid status for the read request entry when read data for that request is returned from an external memory device; and set a Heat Data Valid status for the transaction-ID tracker when the Data Valid status is complete for the first retirement buffer entry number associated with the tracker; an arbitration module configured to arbitrate the order of retirement of read requests with a complete Head Data Valid status, by selecting the next read request for data return, based on their sequence within their respective transaction-ID trackers; a data-return module configured to return the read data to the initiator in the order determined by the arbitration module.

The foregoing and other objects, features, aspects, and advantages of the present invention will become better understood from a careful reading of a detailed description provided herein below with appropriate reference to the accompanying drawings.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text FIGURES, with like reference numbers referring to like structures across the views, wherein:

FIG. 1 illustrating a flowchart for a method for managing read transaction in a memory controller in accordance with an embodiment of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for claims. It should be understood that the drawings and detailed description thereto are not intended to limit the invention to the particular form disclosed, but on the contrary, the invention is to cover all modifications, equivalents and alternatives falling within the scope of the present invention as defined by the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned. Where the abbreviations or technical terms are used, these indicate the commonly accepted meanings as known in the technical field.

The present invention is described hereinafter by various embodiments with reference to the accompanying drawings, wherein reference numerals used in the accompanying drawings correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

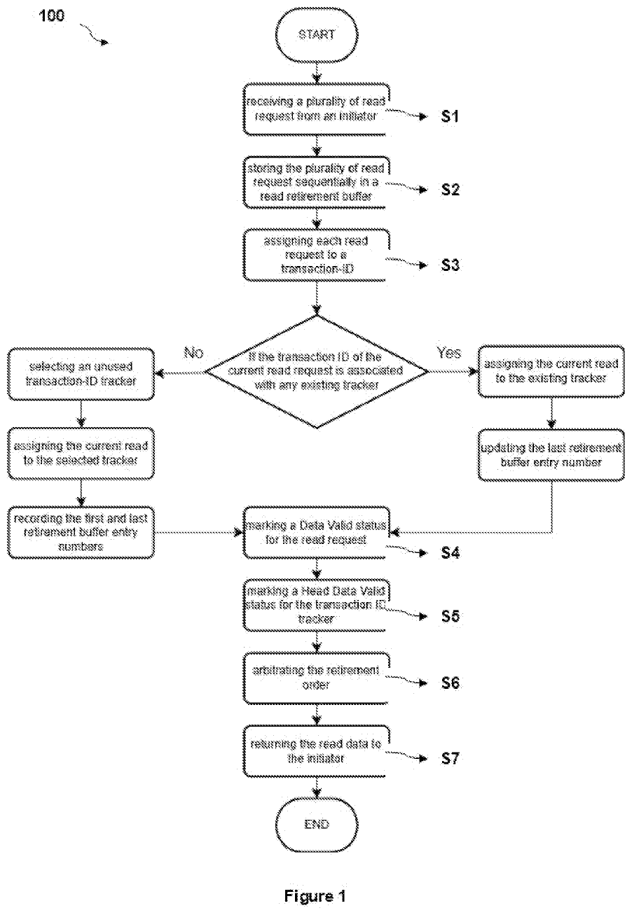

Referring to the drawing as shown in FIG. 1, the present invention will now be described in more detail.

The present invention proposes a method (100) for managing read transaction in a memory controller, as illustrated in FIG. 1. This method (100) begins by receiving a plurality of read request from an initiator (S1), each associated with a unique transaction-ID. These read requests are then stored sequentially in a read retirement buffer (S2), with each entry assigned unique retirement buffer entry number. Subsequently, each read request is assigned to a specific transaction-ID tracker (S3). If a read request's transaction-ID is not previously recorded in the read retirement buffer, an unused tracker is selected and assigned to that request. Conversely, if a read request has the same transaction-ID with an earlier read request in the read retirement buffer, it is assigned to the same existing transaction-ID tracker. Each transaction-ID tracker maintains records of the first and last retirement buffer entry numbers associated with the read requests it tracks.

The transaction ID is a thread identifier for identifying read transactions originating from the same thread. Specifically, in a system which is based on AXI protocol, the transaction ID refers to the AXI ID and the transaction ID tracker refers to the AXI ID tracker.

When the read data for a specific request is returned from the external memory device, its corresponding Data Valid status is marked (S4). Furthermore, when the Data Valid status is marked complete for the first request within a transaction-ID tracker such as the head of the tracker, the Head Data Valid status for that tracker is marked (S5). The method (100) then proceeds to arbitrate the order of retirement (S6) for read request whose respective transaction-ID trackers have the Head Data Valid status marked. This arbitration process involves selecting the next read request for data return based on its sequence within its assigned tracker. Finally, the read data is returned to the initiator (S7) in the order determined by the arbitration process.

In accordance with an embodiment of the present invention, for the read request assigned to the same transaction ID tracker, the retirement buffer entry number of the read request is recorded in an earlier entry of the read request of the same transaction ID tracker. This created a linked list within each tracker, where each entry points to the next read request associated with the same transaction-ID. This linked list structure facilitates efficient tracking of the order of read requests within each tracker, enabling the memory controller to easily determine the next read request to be retired based on its position within the linked list.

In accordance with an embodiment of the present invention, when no unused transaction ID tracker is available for assigning to the read request, the transaction ID tracker already associated with another transaction ID is assigned to the read request for sharing the transaction ID tracker based on predetermined rules. This allocation of trackers ensures that all read requests can be properly managed, even when the number of concurrent transactions exceed the initial number of available trackers. The assignment of read request to shared tracker is governed by predetermined rules, such as assigning the request to the tracker associated with the transaction ID that matches a subset of the lower bits (in binary number) of the current request's transaction-ID.

In accordance with an embodiment of the present invention, the read request is assigned the transaction ID tracker matched with a subset of a lower bits of the transaction ID of the read request. Specifically, the transaction ID tracker can be selected based on the lower [M−1:0] bits of the AXI ID, where M refers to the depth or number of the transaction ID trackers. For example, when all transaction ID trackers 0, 1, 2, 3 (M=4) have been taken, a new read request entry with AXI ID 9 (binary number 1001) will be assigned to transaction ID tracker 1 (binary number 001), for the matching lower three bits, i.e. “001”. This technique distributes read request across the available trackers in a more predictable and consistent manner.

By using a subset of the lower bits, it ensures that read requests are assigned to the same tracker based on defined patterns of transaction ID or AXI ID, improving the efficiency of tracking and managing related request. This approach provides a scalable solution for handling a large number of concurrent transactions while minimizing the potential for tracker contention and improving overall system performance.

It should be understood that the above transaction ID tracker assigning is one of the possible implementations, applicable if the number of transaction ID tracker is a power of 2 number. Other implementations may be utilized for assigning transaction ID trackers, such as round-robin assignment, hashing, or XOR operations to ensure fair and efficient distribution of read requests across the available trackers.

In accordance with an embodiment of the present invention, arbitrating the order of retirement comprises prioritizing the retirement of read request based on their age within the read retirement buffer. This helps to prevent starvation of older transaction and ensures that all read request are eventually serviced in a timely manner and is particularly beneficial in scenarios with high contention resources, as it prevents newer transaction from monopolizing system bandwidth and ensures fair access for all pending read requests. Alternatively, the order of retirement arbitration can be implemented by way of round-robin arbitration, without prioritization measure for simpler implementation.

In accordance with an embodiment of the present invention, arbitrating the order of retirement comprises arranging the retirement of read requests from the same transaction ID consecutively in a non-interleaved manner. For the first transaction, the trackers are arbitrated to choose one with Data Valid status and Head Data Valid status marked. Subsequent read requests belonging to the same transaction-ID are retired consecutively before proceeding to the next transaction-ID. By prioritizing the completion of each transaction-ID before moving on to the next, it improves the predictability of data delivery for applications that require strict ordering of read responses within a specific transaction.

In accordance with an alternative embodiment of the present invention, arbitrating the order of retirement comprises arranging the retirement of read requests of different transaction ID from the previously read requests in an interleaved manner. This means that read request from different transaction-IDs are retired in an alternating sequence. For example, the system may retire a read request from transaction ID 1, followed by a read request from transaction ID 2, and then return to retire another read request from transaction ID 1. This interleaved approach helps to ensure fair resource allocation and prevent starvation of transactions with lower IDs. By distributing the service of read requests across different transaction IDs, interleaved retirement can improve overall system throughput and responsiveness.

In accordance with an embodiment of the present invention, wherein the Data Valid status and Heat Data Valid status are reverted after the read data of the read requests are returned to the initiator. By resetting these status flags, the memory controller can correctly identify and prioritize the next set of read requests for retirement, maintaining the integrity of the tracking mechanism and ensuring smooth and continuous operation of the system.

Furthermore, the present invention proposes a memory controller for managing read transactions, characterized by: a read retirement buffer for sequentially storing read request and associating a read retirement buffer number with each entry of the read requests; a plurality of transaction-ID trackers, each tracker is associated with a group of read requests having the same transaction ID, each transaction-ID tracker stored a first and last retirement buffer entry number of the read requests associated with the transaction ID tracker; a data-validity tracking module configured to: set a Data Valid status for the read request entry when read data for that request is returned from an external memory device; and set a Heat Data Valid status for the transaction-ID tracker when the Data Valid status is complete for the first retirement buffer entry number associated with the tracker; an arbitration module configured to arbitrate the order of retirement of read requests with a complete Head Data Valid status, by selecting the next read request for data return, based on their sequence within their respective transaction-ID trackers; a data-return module configured to return the read data to the initiator in the order determined by the arbitration module.

In accordance with an embodiment of the present invention, the arbitration module is configured to prioritize the retirement of read request based on their age within the read retirement buffer. This age-based prioritization mechanism ensures that older read requests are serviced before newer ones, thereby minimizing latency and preventing starvation of older transactions.

Hereinafter, examples of the present invention will be provided for more detailed explanation. These examples describe a specific embodiment of the invention, utilizing a memory controller running on the AXI protocol. These examples aim to illustrates the key principles and advantages of the present invention that may be more readily understood and put into practical effect from these examples. However, it is to be understood that the following examples are not intended to limit the scope of the present invention in any ways.

### EXAMPLES

### Example 1 Loading New Commands into the Retirement Buffer

In this context, the transaction-ID is synonymous with the AXI ID of the read commands, and consequently, the transaction-ID tracker is also referred to as the AXI ID tracker. Table 1 provides a simplified representation of the Read Retirement Buffer and AXI ID Trackers. The Read Retirement Buffer is depicted as an array of 10 entries (N=10), each capable of storing a single read request. Each entry within the buffer is associated with a unique retirement buffer entry number. Alongside the Read Retirement Buffer, four AXI ID Trackers are shown (M=4), each designed to track read requests associated with a specific AXI ID.

TABLE 1

| Retirement | | | | | AXI ID | | | | | Head |
|---|---|---|---|---|---|---|---|---|---|---|
| Buffer | AXI | | | Next | tracker | AXI ID | | | | Data |
| Entry | ID | DataValid | Valid | Entry | index | tracker | Head | Tail | Valid | Valid |
| 0 | — | 0 | 0 | — | — | 0 | — | — | 0 | 0 |
| 1 | — | 0 | 0 | — | — | 1 | — | — | 0 | 0 |
| 2 | — | 0 | 0 | — | — | 2 | — | — | 0 | 0 |
| 3 | — | 0 | 0 | — | — | 3 | — | — | 0 | 0 |
| 4 | — | 0 | 0 | — | — | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

When a new read command is received, the system first determines the appropriate AXI ID tracker to assign to that command. The assignment process follows a prioritized set of rules. Firstly, if the AXI ID of the new command matches the AXI ID of any existing read request already stored in the buffer, the new command is assigned to the same AXI ID tracker as the existing request. If the AXI ID is not already associated with any tracker, the system selects the next available unused tracker (i.e., a tracker with its “Valid” flag set to 0). In this example, the “find-first” policy is used to select the first available unused tracker. The selection method is not limited but can be based on hash functions or XOR operations. Finally, if all available trackers are in use, the system assigns the new command to an existing tracker based on predetermined rules, such as selecting the tracker based on the lower [M−1:0] bits of the AXI ID. This dynamic allocation strategy ensures that all read requests can be assigned to a tracker, even when the number of concurrent transactions exceeds the initial number of available trackers.

Table 2 below illustrates the initial state of the system when the first command arrives.

TABLE 2

| Retirement | | | | | AXI ID | | | | | Head |
|---|---|---|---|---|---|---|---|---|---|---|
| Buffer | AXI | | | Next | tracker | AXI ID | | | | Data |
| Entry | ID | DataValid | Valid | Entry | index | tracker | Head | Tail | Valid | Valid |
| 0 | 5 | 0 | 1 | — | 0 | 0 | 0 | 0 | 1 | 0 |
| 1 | — | 0 | 0 | — | — | 1 | — | — | 0 | 0 |
| 2 | — | 0 | 0 | — | — | 2 | — | — | 0 | 0 |
| 3 | — | 0 | 0 | — | — | 3 | — | — | 0 | 0 |
| 4 | — | 0 | 0 | — | — | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

This command, with an AXI ID of 5, is received and stored in entry 0 of the Read Retirement Buffer. The “Valid” field for this entry is set to 1, indicating that it is a valid, pending read request. Since AXI ID 5 is not currently being tracked by any of the AXI ID Trackers, and assuming no previous burst activity for this AXI ID, the system selects the first available unused tracker (AXI ID Tracker 0) following the “find-first” policy. The “Valid” field for AXI ID Tracker 0 is set to 1, and the Head and Tail pointers of this tracker are both assigned to the retirement buffer entry 0, indicating that this tracker is now tracking this specific read request.

Furthermore, Table 3 below depicts the state of the system after the arrival of the second command.

TABLE 3

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | — | 0 | 0 | 0 | 0 | 1 | 0 |
| 1 | 10 | 0 | 1 | — | 1 | 1 | 1 | 1 | 1 | 0 |
| 2 | — | 0 | 0 | — | — | 2 | — | — | 0 | 0 |
| 3 | — | 0 | 0 | — | — | 3 | — | — | 0 | 0 |
| 4 | — | 0 | 0 | — | — | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

This command, with an AXI ID of 10, is received and stored in entry 1 of the Read Retirement Buffer. Since AXI ID 10 is not currently being tracked by any of the AXI ID Trackers, the system selects the next available unused tracker, which in this case is AXI ID Tracker 1. The “Valid” field for AXI ID Tracker 1 is set to 1, and both the Head and Tail pointers of this tracker are updated to point to the newly added retirement buffer entry 1, indicating that this tracker is now tracking this specific read request.

Table 4 below illustrates the state of the system after the arrival of the third command.

TABLE 4

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | — | 0 | 0 | 0 | 0 | 1 | 0 |
| 1 | 10 | 0 | 1 | 2 | 1 | 1 | 1 | 2 | 1 | 0 |
| 2 | 10 | 0 | 1 | — | 1 | 2 | — | — | 0 | 0 |
| 3 | — | 0 | 0 | — | — | 3 | — | — | 0 | 0 |
| 4 | — | 0 | 0 | — | — | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

This command, also with an AXI ID of 10, is received and stored in entry 2 of the Read Retirement Buffer. Since AXI ID 10 is already being tracked by AXI ID Tracker 1 (as evidenced by the presence of a previous read request with the same AXI ID in entry 1), the new command is assigned to the same AXI ID Tracker 1. The Tail pointer of AXI ID Tracker 1 is then updated to point to this new entry 2, effectively extending the list of read requests associated with this AXI ID within the tracker. This action dictates that read requests with the same transaction ID should be assigned to the same AXI ID Tracker.

TABLE 5

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 2 | 1 | 0 |
| 2 | 10 | 0 | 1 | — | 1 | 2 | — | — | 0 | 0 |
| 3 | 5 | 0 | 1 | — | 0 | 3 | — | — | 0 | 0 |
| 4 | — | 0 | 0 | — | — | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

Moreover, Table 5 above illustrates the state of the system after the arrival of the fourth command. This command, with an AXI ID of 5, is received and stored in entry 3 of the Read Retirement Buffer. Since AXI ID 5 is already being tracked by AXI ID Tracker 0. As evidenced by the presence of a previous read request with the same AXI ID in entry 0. The new command is assigned to the same AXI ID Tracker 0. The Tail pointer of AXI ID Tracker 0 is then updated to point to this new entry 3, effectively extending the list of read requests associated with this AXI ID within the tracker. This action dictates that read requests with the same transaction ID should be assigned to the same AXI ID Tracker.

TABLE 6

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 2 | 1 | 0 |
| 2 | 10 | 0 | 1 | — | 1 | 2 | 4 | 4 | 1 | 0 |
| 3 | 5 | 0 | 1 | — | 0 | 3 | — | — | 0 | 0 |
| 4 | 11 | 0 | 1 | — | 2 | | | | | |
| 5 | — | 0 | 0 | — | — | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

Next Table 6 illustrates the state of the system after the arrival of the fifth command. This command, with an AXI ID of 11, is received and stored in entry 4 of the Read Retirement Buffer. Since AXI ID 11 is not currently being tracked by any of the AXI ID Trackers, the system selects the next available unused tracker, which in this case is AXI ID Tracker 2. The “Valid” field for AXI ID Tracker 2 is set to 1, and both the Head and Tail pointers of this tracker are updated to point to the newly added retirement buffer entry 4.

TABLE 7

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 2 | 1 | 0 |
| 2 | 10 | 0 | 1 | — | 1 | 2 | 4 | 4 | 1 | 0 |
| 3 | 5 | 0 | 1 | — | 0 | 3 | 5 | 5 | 1 | 0 |
| 4 | 11 | 0 | 1 | — | 2 | | | | | |
| 5 | 8 | 0 | 1 | — | 3 | | | | | |
| 6 | — | 0 | 0 | — | — | | | | | |
| 7 | — | 0 | 0 | — | — | | | | | |
| 8 | — | 0 | 0 | — | — | | | | | |
| 9 | — | 0 | 0 | — | — | | | | | |

Table 7 illustrates the state of the system after the arrival of the sixth command. This command, with an AXI ID of 8, is received and stored in entry 5 of the Read Retirement Buffer. Since AXI ID 8 is not currently being tracked by any of the AXI ID Trackers, the system selects the next available unused tracker, which in this case is AXI ID Tracker 3. The “Valid” field for AXI ID Tracker 3 is set to 1, and both the Head and Tail pointers of this tracker are updated to point to the newly added retirement buffer entry 5.

TABLE 8

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 6 | 1 | 0 |
| 2 | 10 | 0 | 1 | 6 | 1 | 2 | 4 | 4 | 1 | 0 |
| 3 | 5 | 0 | 1 | — | 0 | 3 | 5 | 5 | 1 | 0 |
| 4 | 11 | 0 | 1 | — | 2 | | | | | |
| 5 | 8 | 0 | 1 | — | 3 | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Moreover, Table 8 illustrates the state of the system after the arrival of the seventh command. This command, with an AXI ID of 9, is received and stored in entry 6 of the Read Retirement Buffer. Since AXI ID 9 is not currently being tracked by any of the AXI ID Trackers and all available trackers (Tracker 0 to Tracker 3) are already in use, the system needs to assign the command to an existing tracker. To handle this scenario, the system employs a mechanism to distribute read requests across the available trackers when all trackers are occupied. In this example, the system examines the lower bits of the AXI ID specifically, the lower three bits in this case, as there are four trackers to determine the target tracker. Based on the value of these lower bits, the system selects AXI ID Tracker 1 to handle this command.

### Example 2 Retiring Transaction

The Data valid field associated with a read request in the Read Retirement buffer is set to 1 when the corresponding read data is returned from the external memory device to the memory controller. The order of data return from the memory device may not necessarily correspond to the order in which the read request were originally received and stored in the buffer.

Table 9 below highlights the situation where the system has multiple read requests with their Data Valid field set to 1, indicating that the corresponding read data has been received from the Memory Device. Specifically, entries 3, 4, and 5 in the Read Retirement Buffer now have their Data Valid fields set to 1. However, not all of these entries can be immediately retired. The table emphasizes the importance of adhering to the AXI ID ordering rule, which mandates that read requests within the same transaction ID must be returned to the initiator in the order they were received. Therefore, entry 3, although its Data Valid field is set, cannot be retired immediately because it is not the first read request for AXI ID 5 (entry 0 holds the first request for AXI ID 5). Consequently, only entries 4 and 5 are eligible for immediate retirement, as they represent the “head” of their respective transaction ID trackers (Tracker 2 and Tracker 3) and their Data Valid fields are set to 1. The table then introduces the concept of an arbiter, which is responsible for selecting the next read request to be retired from among the eligible candidates.

TABLE 9

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 5 | 1 | 0 |
| 2 | 10 | 0 | 1 | 6 | 1 | 2 | 4 | 6 | 1 | 1 |
| 3 | 5 | 1 | 1 | — | 0 | 3 | 5 | 5 | 1 | 1 |
| 4 | 11 | 1 | 1 | — | 2 | | | | | |
| 5 | 8 | 1 | 1 | — | 3 | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

TABLE 10

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 6 | 1 | 0 |
| 2 | 10 | 0 | 1 | 6 | 1 | 2 | 4 | 4 | 0 | 0 |
| 3 | 5 | 1 | 1 | — | 0 | 3 | 5 | 5 | 1 | 1 |
| 4 | 11 | 0 | 0 | — | — | | | | | |
| 5 | 8 | 1 | 1 | — | 3 | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Table 10 provides a detailed illustration of the arbitration process, including the selection of the next tracker for retirement based on age-based prioritization and the subsequent updates to the tracker's status flags. It first identifies the AXI ID Trackers with the Head Data Valid field set to 1. In this specific scenario, only AXI ID Trackers 2 and 3 meet this condition. Assuming an age-based arbitration strategy, the arbiter selects AXI ID Tracker 2 for retirement, as it represents the older of the two eligible trackers. After the read data associated with entry 4 (the head of AXI ID Tracker 2) is retired, the Data Valid and Valid fields for this entry are reset to 0. Since AXI ID Tracker 2 was only tracking a single entry—entry 4, its Head and Tail pointers now point to the same invalid entry. Consequently, the Valid field for AXI ID Tracker 2 is also reset to 0, along with its Head Data Valid field.

TABLE 11

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 1 | 3 | 0 | 0 | 0 | 3 | 1 | 0 |
| 1 | 10 | 0 | 1 | 2 | 1 | 1 | 1 | 6 | 1 | 0 |
| 2 | 10 | 0 | 1 | 6 | 1 | 2 | 4 | 4 | 0 | 0 |
| 3 | 5 | 1 | 1 | — | 0 | 3 | 5 | 5 | 0 | 0 |
| 4 | 11 | 0 | 0 | — | — | | | | | |
| 5 | 8 | 0 | 0 | — | — | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Table 11 shows the next step in the retirement process. Since Retirement buffer entry 5, associated with AXI ID 8, has its Data Valid field set to 1 and is the “Head” entry of its corresponding AXI ID Tracker 3, it is now eligible for retirement. The arbiter selects this entry for retirement in the next cycle. Upon retiring entry 5, the Data Valid field for entry 5 in the Read Retirement Buffer is reset to 0, indicating that this entry has been processed, and the read data has been returned to the initiator. The Valid field for entry 5 in the Read Retirement Buffer is also reset to 0, signifying that this buffer entry is now available for storing a new read request. Since entry 5 was the last entry tracked by AXI ID Tracker 3, the Valid field for AXI ID Tracker 3 is also reset to 0, indicating that this tracker is no longer tracking any active read requests.

TABLE 12

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 1 | 1 | 3 | 0 | 0 | 0 | 3 | 1 | 1 |
| 1 | 10 | 1 | 1 | 2 | 1 | 1 | 1 | 6 | 1 | 1 |
| 2 | 10 | 0 | 1 | 6 | 1 | 2 | 4 | 4 | 0 | 0 |
| 3 | 5 | 1 | 1 | — | 0 | 3 | 5 | 5 | 0 | 0 |
| 4 | 11 | 0 | 0 | — | — | | | | | |
| 5 | 8 | 0 | 0 | — | — | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Multiple read requests received their corresponding read data from the memory device is shown in Table 12. The read requests stored in Retirement Buffer entries 0 and 1 have now had their Data Valid fields set to 1, indicating that the necessary read data has been received. This situation results in two AXI ID Trackers (the trackers associated with the read requests in entries 0 and 1) having their Head Data Valid fields set to 1, signifying that the head of each of these trackers now contains valid data that is ready for retirement. This highlights the situation where multiple trackers have valid data available for retirement, setting the stage for the arbitration process to select the next read request to be returned to the initiator.

TABLE 13

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 0 | 3 | 0 | 0 | 3 | 3 | 1 | 1 |
| 1 | 10 | 1 | 1 | 2 | 1 | 1 | 1 | 6 | 1 | 1 |
| 2 | 10 | 0 | 1 | 6 | 1 | 2 | 4 | 4 | 0 | 0 |
| 3 | 5 | 1 | 1 | — | 0 | 3 | 5 | 5 | 0 | 0 |
| 4 | 11 | 0 | 0 | — | — | | | | | |
| 5 | 8 | 0 | 0 | — | — | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Furthermore, the state of the system after the retirement of the read request stored in Retirement Buffer entry 0 is in Table 13. Although entry 0 has been retired, AXI ID Tracker 0 remains valid because it is still tracking another active read request (the one stored in entry 3). To maintain accurate tracking, the Head pointer of AXI ID Tracker 0 is updated to point to the next entry in the sequence, which is entry 3. Since the read data for the read request stored in entry 3 has already been received where its Data Valid field is set to 1, the Head Data Valid field of AXI ID Tracker 0 remains set to 1, indicating that the head of this tracker still contains valid data that is ready for retirement.

TABLE 14

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | index | tracker | Head | Tail | Valid | Valid |
| 0 | 5 | 0 | 0 | 3 | 0 | 0 | 3 | 3 | 0 | 0 |
| 1 | 10 | 1 | 1 | 2 | 1 | 1 | 1 | 6 | 1 | 1 |
| 2 | 10 | 0 | 1 | 6 | 1 | 2 | 4 | 4 | 0 | 0 |
| 3 | 5 | 0 | 0 | — | 0 | 3 | 5 | 5 | 0 | 0 |
| 4 | 11 | 0 | 0 | — | — | | | | | |
| 5 | 8 | 0 | 0 | — | — | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Table 14 presents a decision point where the system must choose the next read request for retirement. At this stage, two entries are eligible for retirement: Retirement Buffer entry 3 (associated with AXI ID 5) and Retirement Buffer entry 1 (associated with AXI ID 10). If the implementation prioritizes non-interleaving, it will select Retirement Buffer entry 3 for retirement. This ensures that all read requests belonging to the same transaction ID, AXI ID 5 in this case, are retired consecutively before moving on to the next transaction ID. Since entry 3 is the last entry tracked by AXI ID Tracker 0, retiring this entry will effectively complete the processing of all read requests associated with AXI ID 5. Consequently, both the Valid fields of AXI ID Tracker 0 are reset to 0, indicating that this tracker is no longer active. The system can then proceed to retire entry 1 in the next cycle.

TABLE 15

| Retirement | | | | | AXI ID | | | | | Head |
|---|---|---|---|---|---|---|---|---|---|---|
| Buffer | AXI | Data | | Next | tracker | AXI ID | | | | Data |
| Entry | ID | Valid | Valid | Entry | Index | tracker | Head | Tail | Valid | Valid |
| 0 | 5 | 0 | 0 | 3 | 0 | 0 | 3 | 3 | 1 | 1 |
| 1 | 10 | 0 | 0 | 2 | 1 | 1 | 2 | 6 | 1 | 0 |
| 2 | 10 | 0 | 1 | 6 | 1 | 2 | 4 | 4 | 0 | 0 |
| 3 | 5 | 1 | 1 | — | 0 | 3 | 5 | 5 | 0 | 0 |
| 4 | 11 | 0 | 0 | — | — | | | | | |
| 5 | 8 | 0 | 0 | — | — | | | | | |
| 6 | 9 | 0 | 1 | — | 1 | | | | | |
| 7 | — | 0 | 0 | — | — | | | | | |
| 8 | — | 0 | 0 | — | — | | | | | |
| 9 | — | 0 | 0 | — | — | | | | | |

Meanwhile, Table 15 explores the alternative scenario where AXI ID interleaving is preferred. In this case, if AXI ID interleaving is selected, the system prioritizes retiring Retirement Buffer entry 1, which belongs to a different transaction ID (AXI ID 10). This interleaving strategy helps to distribute the service of read requests more evenly across different transaction IDs, preventing potential starvation for transactions with less frequent requests. Upon retiring buffer entry 1, the Head field of AXI ID Tracker 1 is updated to point to the next entry in the sequence, which is entry 2, which can be traced from the retirement buffer entry 1 in the “Next Entry” field. However, since buffer entry 2 has not yet received its read data, the Head Data Valid field of AXI ID Tracker 2 is reset to 0. This indicates that the head of this tracker currently does not contain valid data ready for retirement. With entry 1 retired, the system can then proceed to retire entry 3 in the next cycle, as it is now the head of its respective tracker (AXI ID Tracker 0) and its Data Valid field is already set to 1.

The examples demonstrate the operation of the invention. The order of read data return can vary depending on the chosen arbitration strategy. For instance, with AXI ID 5 and AXI ID 10, the order could be entry 0 (AXI ID 5), entry 1 (AXI ID 10), and then entry 3 (AXI ID 5), or it could be entry 0 (AXI ID 5), entry 3 (AXI ID 5), and then entry 1 (AXI ID 10). Importantly, both orders adhere to the AXI ID ordering rules, ensuring that read requests within the same transaction ID are returned in the correct sequence. The key advantage of this invention lies in its ability to significantly reduce the complexity of managing and comparing transactions by focusing on a limited number of AXI ID Trackers (M) instead of examining the entire Read Retirement Buffer (K entries). This simplification leads to improved performance, reduced latency, and a more manageable design, especially in systems with a large number of outstanding read transactions. The number of trackers (M) can be adjusted based on system requirements and resource constraints to achieve an optimal balance between performance and hardware complexity.

The present invention addresses the limitations of conventional memory controllers for managing out-of-order read transactions. Unlike conventional approaches that often involve searching through the entire read retirement buffer to determine the next read request to be serviced, this invention introduces an approach that leverages dedicated transaction-ID trackers to efficiently group and manage read requests associated with the same transaction ID. This approach significantly reduces the complexity and hardware overhead associated with the arbitration process, leading to improved performance and reduced latency, especially in systems with a large number of outstanding read transactions.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for managing read transaction in a memory controller, comprising:
receiving a plurality of read request from an initiator requesting read data from an external memory device, each read request is associated with a transaction ID;
storing the plurality of read request sequentially in a read retirement buffer, with a retirement buffer entry number associated with each entry of the read request;
assigning each read request to a transaction-ID tracker based on its transaction ID, wherein:
an unused transaction ID tracker is selected and assigned to the read request if the transaction ID is not previously recorded in the read retirement buffer,
the read request having the same transaction ID with an earlier read request in the read retirement buffer is assigned to the same transaction ID tracker,
the transaction ID tracker is recorded with a first retirement buffer entry number and a last retirement entry buffer number associated with the transaction ID tracker;
marking a Data Valid status for the read request when the read data for the read request is returned from the external memory device;
marking a Head Data Valid status for the transaction ID tracker when the Data Valis is marked complete for the first retirement buffer entry number associated with the transaction ID tracker;
arbitrating the order of retirement of said read request where the Head Data Valid status is marked complete, by selecting the next request for data return, based on their sequence within their respective transaction-ID trackers; and
returning read data to the initiator in the order determined during arbitration process.

2. The method of claim 1, wherein for the read request assigned to the same transaction ID tracker, the retirement buffer entry number of the read request is recorded in an earlier entry of the read request of the same transaction ID tracker.

3. The method of claim 1, wherein when no unused transaction ID tracker is available for assigning to the read request, the transaction ID tracker already associated with another transaction ID is assigned to the read request for sharing the transaction ID tracker based on predetermined rules.

4. The method of claim 3, wherein the read request is assigned the transaction ID tracker matched with a subset of a lower bits of the transaction ID of the read request.

5. The method of claim 1, wherein arbitrating the order of retirement comprises prioritizing the retirement of read request based on their age within the read retirement buffer.

6. The method of claim 1, wherein arbitrating the order of retirement comprises arranging the retirement of read requests from the same transaction ID consecutively in a non-interleaved manner.

7. The method of claim 1, wherein arbitrating the order of retirement comprises arranging the retirement of read requests of different transaction ID from the previously read requests in an interleaved manner.

8. The method of claim 1, wherein the Data Valid status and Heat Data Valid status are reverted after the read data of the read requests are returned to the initiator.

9. A memory controller for managing read transactions, comprising:
a read retirement buffer for sequentially storing read requests and associating a read retirement buffer number with each entry of the read requests;
a plurality of transaction-ID trackers, each tracker is associated with a group of read requests having the same transaction ID, each transaction-ID tracker stored a first and last retirement buffer entry number of the read requests associated with the transaction ID tracker;
a data-validity tracking module configured to:
set a Data Valid status for the read request entry when read data for that request is returned from an external memory device; and
set a Heat Data Valid status for the transaction-ID tracker when the Data Valid status is complete for the first retirement buffer entry number associated with the tracker;
an arbitration module configured to arbitrate the order of retirement of read requests with a complete Head Data Valid status, by selecting the next read request for data return, based on their sequence within their respective transaction-ID trackers;
a data-return module configured to return the read data to the initiator in the order determined by the arbitration module.

10. The memory controller of claim 9, wherein the arbitration module is configured to prioritize the retirement of read request based on their age within the read retirement buffer.
